(19) United States
(12) Patent Application Publication
(10) Pub. No.: US 2014/0019648 A1
(43) Pub. Date: Jan. 16, 2014

(54) KEYBOARD, VIDEO AND MOUSE (KVM) SWITCH INDICATOR AND KVM SWITCH SYSTEM USING THE SAME

(71) Applicant: Hon Hai Precision Industry Co., Ltd., New Taipei (TW)

(72) Inventor: CHUN-CHE HUANG, New Taipei (TW)

(21) Appl. No.: 13/927,138

(22) Filed: Jun. 26, 2013

(30) Foreign Application Priority Data
Jul. 12, 2012 (TW) 101125053

(51) Int. Cl. G06F 3/02

(52) U.S. Cl. CPC G06F 3/0227
USPC 710/19

(57) ABSTRACT

A keyboard, video and mouse (KVM) switch indicator is electronically connected between a USB port of a KVM switch and a USB port of a computer. The KVM switch indicator includes a status indicator and a controller. The status indicator indicates an electronic status of the computer electronically connected to the peripheral equipment. The controller sets trigger values of input voltages inputted into the controller, detects voltage values of the USB port of the computer, determines whether the voltage values of the USB port of the computer are same as the trigger values, and outputs current to the status indicator according to determination of the controller. If the voltage values detected by the controller are same as the trigger values, the controller outputs current to light the status indicator or to sound the status indicator.

### BACKGROUND

1. Technical Field

The present disclosure relates to keyboard, video and mouse (KVM) switch indicators, and more particularly to a KVM switch indicator connected to a universal serial bus (USB) port of a computer and a KVM switch system.

2. Description of Related Art

A number of computers are sometimes used to complete complex tasks. The computers share peripheral equipment, such as a keyboard, a display screen and a mouse, and it is easy for users to operate. A keyboard, video and mouse (KVM) switch is connected between the peripheral equipment and the computers through cables, and is used to switch between the computers. When one of the computers malfunctions, the computer connected to the peripheral equipments must be found by following the cables. However, the cables are always disorderly, and thus it will take a long time to find the computer connected to the peripheral equipments.

Therefore, it is desired to provide a KVM switch indicator and a KVM switch system which can overcome the above-described deficiencies.

### BRIEF DESCRIPTION OF THE DRAWINGS

Many aspects of the present KVM switch indicator and KVM switch system can be better understood with reference to the following drawings. The components in the various drawings are not necessarily drawn to scale, the emphasis instead being placed upon clearly illustrating the principles of the present KVM switch indicator and KVM switch system.

FIG. 1 is a block diagram of a KVM switch system including a peripheral equipment, a KVM switch, a plurality of KVM switch indicators and a plurality of computers according to an exemplary embodiment of the present disclosure.

FIG. 2 is a circuit diagram of the KVM switch, the KVM switch indicator and the computer shown in FIG. 1.

FIG. 3 is a block diagram of a controller of the KVM switch indicator shown in FIG. 1.

### DETAILED DESCRIPTION

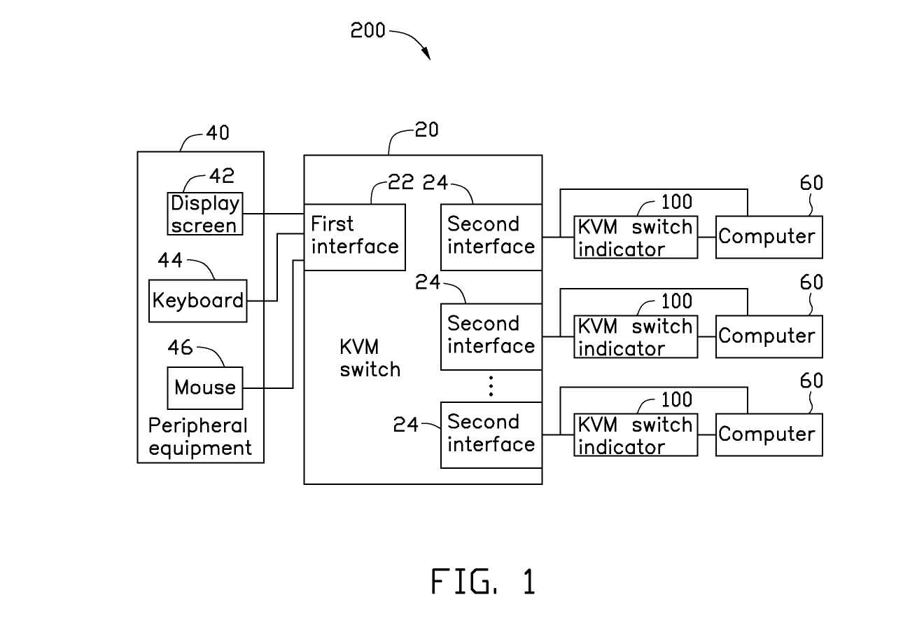

FIG. 1 is a block diagram of a KVM switch system 200 including a peripheral equipment 40, a KVM switch 20, a plurality of KVM switch indicators 100, and a plurality of computers 60 according to an exemplary embodiment of the present disclosure.

The peripheral equipment 40 includes a display screen 42, a keyboard 44, and a mouse 46, where the peripheral equipment 40 is electronically connected to the KVM switch 20. Each computer 60 is electronically connected to one KVM switch indicator 100 and the KVM switch 20. The KVM switch indicator 100 is electronically connected to the KVM switch 20 through a cable. The KVM switch 20 switches between the computers 60 so that each of the computers 60 can use the display screen 42, the mouse 46, and the keyboard 44. The peripheral equipment 40 is electronically connected to the computers 60 and is used to operate the computers 60. The KVM switch indicator 100 is used to indicate whether the computer 60 is electronically connected to the peripheral equipment 40.

The KVM switch 20 includes a first interface 22 and a plurality of second interfaces 24 connected to the plurality of computers 60. In the embodiment, the first interface 22 includes a video graphics array (VGA) port, a digital visual interface (DVI) port, and universal serial bus (USB) ports. The KVM switch 20 is electronically connected to the display screen 42, the keyboard 44 and the mouse 46 through the first interface 22. Each second interface 24 includes a VGA port, a DVI port, and a USB port. The KVM switch 20 is electronically connected to one computer 60 through a second interface 24.

The VGA ports or the DVI ports of the second interfaces 24 can be electronically connected to display screens or graphics card interfaces of the computers 60. The KVM switch 20 including the VGA ports and the DVI ports can be used for various computers.

The display screen 42 is electronically connected to the VGA port or the DVI port of the first interface 22. The keyboard 44 and the mouse 46 are electronically connected to the USB ports of the first interface 22.

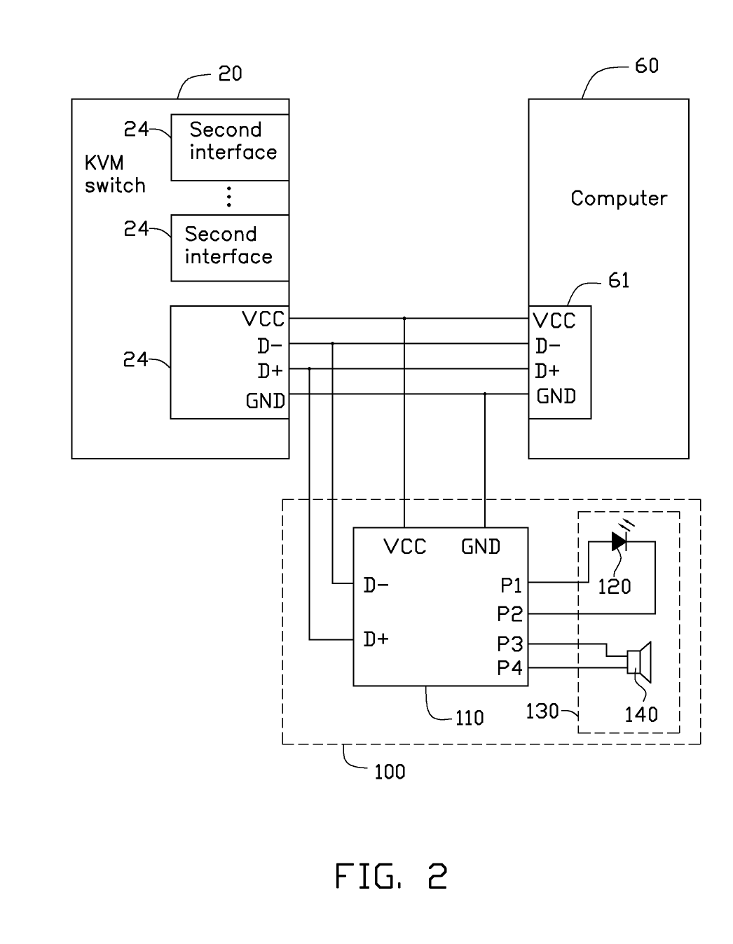

Each computer 60 is electronically connected to one second interface 24, and each KVM switch indicator 100 is electronically connected between the USB port of the second interface 24 and a USB port 61 (shown in FIG. 2) of the computer 60. The KVM switch 20 allows the peripheral equipment 40 to be electronically connected to any one of the plurality of computers 60, and the KVM switch indicator 100 connected to the computer 60 indicates whether the computer 60 is electronically connected to the peripheral equipment 40. A user can operate the computer 60 through the peripheral equipment 40.

In FIG. 2, the KVM switch indicator 100 is electronically connected between the KVM switch 20 and the computer 60. Each USB port of the second interface 24 and the USB port 61 includes a power pin VCC, a negative differential signal pin D−, a positive differential signal pin D+, and a ground pin GND. The USB port of the second interface 24 is electronically connected to the USB port 61 through a USB cable.

The KVM switch indicator 100 includes a controller 110 and a status indicator 130 electronically connected to the controller 110. The controller 110 includes a plurality of detection pins and a plurality of output pins P1, P2, P3, and P4. In the embodiment, the detection pins includes a power pin VCC, a negative differential signal pin D−, a positive differential signal pin D+, and a ground pin GND. The power pin VCC of the controller 110 is electronically connected to the power pin VCC of the computer 60, and the negative differential signal pin D− of the controller 110 is electronically connected to the negative differential signal pin D− of the computer 60. The positive differential signal pin D+ of the controller 110 is electronically connected to the positive differential signal pin D+ of the computer 60, and the ground pin GND of the controller 110 is electronically connected to the ground pin GND of the computer 60. The status indicator 130 is used for indicating the computer 60 electronically connected to the peripheral equipment 40, in the embodiment, the status indicator 130 includes a light emitting diode (LED) 120 and a speaker 140. An anode of the LED 120 is electronically connected to the output pin P1, and a cathode of the LED 120 is electronically connected to the output pin P2. The speaker 140 is electronically connected between the output pins P3 and P4.

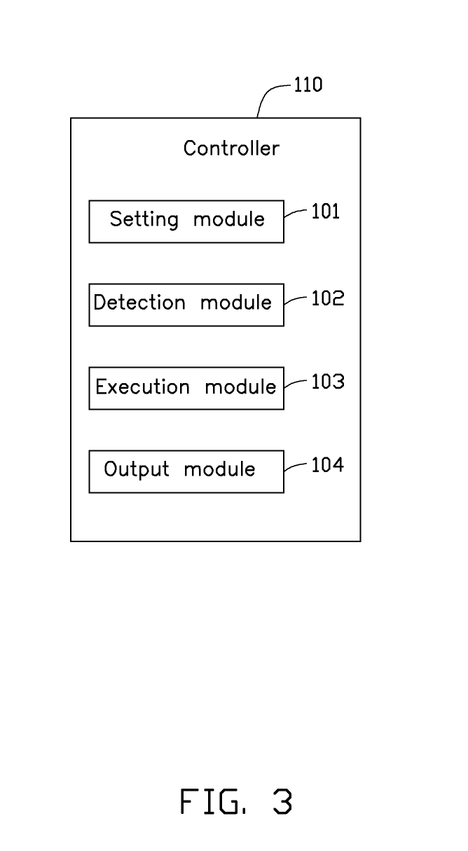

Also referring to FIG. 3, the controller 110 includes a setting module 101, a detection module 102, an execution module 103, and an output module 104. In general, the word “module” as used herein, refers to logic embodied in hardware or firmware, or to a collection of software instructions, written in a programming language, such as, for example, Java, C, or assembly. One or more software instructions in the module may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer readable medium or other computer storage system. The setting module 101 sets trigger values of input voltages inputted into the controller 110. The detection module 102 detects voltage values of the controller 110's negative differential signal pin D− and the controller 110's positive differential signal pin

D+. The execution module 103 determines whether the voltage values detected by the detection module 102 are same as the trigger values, if the voltage values detected by the detection module 102 are the same as the trigger values, the execution module 103 allows the output module 104 to output current to the plurality of output pins P1, P2, P3, and P4.

The controller 110 can receive power supply from the computer 60 through the power pin VCC of the controller 110. In the embodiment, the power pin VCC of the controller 110 is 5 volts. The setting module 101 sets a trigger value when the negative differential signal pin D− of the controller 110 detects a low level voltage (i.e., logic 0) and the positive differential signal pin D+ of the controller 110 detects a high level voltage (i.e., logic 1). When the KVM switch 20 switches from a current computer 60 to another computer 60, the USB port 61 of the current computer 60 enters a suspend mode, and the voltage of the negative differential signal pin D− of the USB port 61 is at a high level (i.e., logic 1), the voltage of the positive differential signal pin D+ of the USB port 61 is at a low level (i.e., logic 0). The detection module 102 detects the voltage values of the controller 110's negative differential signal pin D− and the controller 110's positive differential signal pin D+. In addition, the execution module 103 determines that voltage values detected by the detection module 102 are not same as the trigger values, and then no current is output from the plurality of output pins P1, P2, P3, and P4. The LED 120 does not emit light, and the speaker 140 is muted.

When the KVM switch 20 switches from other computer 60 to the current computer 60, the USB port 61 of the current computer 60 works properly, and the voltage of the negative differential signal pin D− of the USB port 61 is at a low level, the voltage of the positive differential signal pin D+ of the USB port 61 is at a high level. The detection module 102 detects the voltage values of the controller 110's negative differential signal pin D− and the controller 110's positive differential signal pin D+. The execution module 103 determines that voltage values detected by the detection module 102 are same as the trigger values and allows the output module 104 to output current to the plurality of output pins P1, P2, P3, and P4. The LED 120 emits light, and the speaker 140 sounds. The user can easily find out which computer 60 is electronically connected to the peripheral equipment 40.

The KVM switch indicator 100 is electronically connected between the USB port of the KVM switch 20 and the USB port 61 of the computer 60, detects voltage variations of the USB port 61, and allows the LED 120 to emit light and the speaker 140 to sound to indicate that the current computer 60 is electronically connecting to the peripheral equipment 40. The KVM switch indicator 100 has simple structure and is easy to use.

In an alternative exemplary embodiment, the KVM switch 20 only includes VGA ports, and when there is a need to connect to DVI ports of computers, the DVI ports of the computers can be connected to the VGA ports of the KVM switch 20 through adapters.

In an alternative exemplary embodiment, the status indicator 130 may include either the LED 120 or the speaker 140.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A keyboard, video and mouse (KVM) switch indicator for indicating whether a computer is electronically connected to a peripheral equipment under the control of a KVM switch, the KVM switch indicator electronically connected between a USB port of the KVM switch and a USB port of the computer, the KVM switch indicator comprising:
a status indicator indicating an electronic status of the computer electronically connected to the peripheral equipment; and
a controller comprising:
a setting module setting trigger values of input voltages inputted into the controller;
a detection module detecting voltage values of the USB port of the computer;
an execution module determining whether the voltage values detected by the detection module are same as the trigger values; and
an output module outputting current to the status indicator under the control of the execution module;
wherein if the voltage values detected by the detection module are same as the trigger values, the execution module allows the output module to output the current to the status indicator to light the status indicator or to sound the status indicator.

2. The KVM switch indicator as claimed in claim 1, wherein the controller comprises a power pin VCC, a negative differential signal pin D−, a positive differential signal pin D+ and a ground pin GND, the power pin VCC of the controller is electronically connected to a power pin VCC of the computer, and the negative differential signal pin D− of the controller is electronically connected to a negative differential signal pin D− of the compute, the positive differential signal pin D+ of the controller is electronically connected to a positive differential signal pin D+ of the computer, and the ground pin GND of the controller is electronically connected to a ground pin GND of the computer.

3. The KVM switch indicator as claimed in claim 2, wherein the controller further comprises a plurality of output pins, the plurality of output pins are electronically connected to the status indicator.

4. The KVM switch indicator as claimed in claim 3, wherein the status indicator includes a light emitting diode (LED) and a speaker, the LED and the speaker are electronically connected two output pins of the controller, respectively.

5. The KVM switch indicator as claimed in claim 4, wherein the setting module sets a low level voltage of the negative differential signal pin D− of the controller and a high level voltage of the positive differential signal pin D+ of the controller as the trigger values and the detection module detects the voltage values of the controller's negative differential signal pin D− and the controller's positive differential signal pin D+; if the execution module determines that voltage values detected by the detection module are not same as the trigger values, no current is output from the plurality of output pins, the LED does not emit light, and the speaker is muted.

6. The KVM switch indicator as claimed in claim 5, wherein if the execution module determines that voltage values detected by the detection module are same as the trigger values and allows the output module to output current to the plurality of output pins, the LED emits light and the speaker sounds.

7. A keyboard, video and mouse (KVM) switch system, comprising:
a peripheral equipment;
a plurality of computers;
a KVM switch, the KVM switch electronically connected between the peripheral equipment and the plurality of computers and switching between the plurality computers; and
a plurality of KVM switch indicators, each KVM switch indicator electronically connected between one computer and the KVM switch, and each KVM switch indicator comprising:
a status indicator indicating an electronic status of the computer electronically connecting to the peripheral equipment; and
a controller comprising:
a setting module setting trigger values of input voltages inputted into the controller;
a detection module detecting voltage values of the USB port of the computer;
an execution module determining whether the voltage values detected by the detection module are same as the trigger values; and
an output module outputting current to the status indicator under the control of the execution module;
wherein if the voltage values detected by the detection module are same as the trigger values, the execution module allows the output module to output the current to the status indicator to light the status indicator or to sound the status indicator.

8. The KVM switch system as claimed in claim 7, wherein the controller comprises a power pin VCC, a negative differential signal pin D−, a positive differential signal pin D+ and a ground pin GND, the power pin VCC of the controller is electronically connected to a power pin VCC of the computer, and the negative differential signal pin D− of the controller is electronically connected to a negative differential signal pin D− of the compute, the positive differential signal pin D+ of the controller is electronically connected to a positive differential signal pin D+ of the computer, and the ground pin GND of the controller is electronically connected to a ground pin GND of the computer.

9. The KVM switch system as claimed in claim 8, wherein the controller further comprises a plurality of output pins, the plurality of output pins are electronically connected to the status indicator.

10. The KVM switch system as claimed in claim 9, wherein the status indicator includes a light emitting diode (LED) and a speaker, the LED and the speaker are electronically connected two output pins of the controller, respectively.

11. The KVM switch system as claimed in claim 10, wherein the setting module sets a low level voltage of the negative differential signal pin D− of the controller and a high level voltage of the positive differential signal pin D+ of the controller as the trigger values and the detection module detects the voltage values of the controller's negative differential signal pin D− and the controller's positive differential signal pin D+; if the execution module determines that voltage values detected by the detection module are not same as the trigger values, no current is output from the plurality of output pins, the LED does not emit light, and the speaker is muted.

12. The KVM switch system as claimed in claim 11, wherein if the execution module determines that voltage values detected by the detection module are same as the trigger values and allows the output module to output current to the plurality of output pins, the LED emits light, and the speaker sounds.

13. The KVM switch system as claimed in claim 7, wherein the KVM switch comprises a first interface and a plurality of second interfaces, the first interface is electronically connected to the peripheral equipment, the plurality of second interfaces are electronically connected to the plurality of computers, respectively; the first interface and each second interface comprise a video graphics array (VGA) port, a digital visual interface (DVI) port, and universal serial bus (USB) ports.

14. The KVM switch system as claimed in claim 13, wherein the peripheral equipment comprises a display screen, a keyboard and a mouse; the display screen is electronically connected to the VGA port or the DVI port of the first interface, and the keyboard and the mouse are electronically connected to the USB ports of the first interface.
